(19) United States
(12) Patent Application Publication
(10) Pub. No.: US 2024/0424481 A1
(43) Pub. Date: Dec. 26, 2024

(54) BIODEGRADABLE STARCH/POLYACRYLATE SUPER WATER ABSORBENTS PREPARED BY GAMMA-IRRADIATION

(71) Applicant: Department of Science and Technology - Philippine Nuclear Research Institute (DOST-PNRI), Quezon City (PH)

(72) Inventors: Lucille Abad, Quezon City (PH); Lorna Relleve, Quezon City (PH); Alvin Kier Gallardo, Quezon City (PH); John Andrew Luna, Quezon City (PH); Fernando Aurigue, Quezon City (PH); Bin Jeremiah Barba, Quezon City (PH); Patrick Jay Cabalar, Quezon City (PH); Charito Aranilla, Quezon City (PH)

(21) Appl. No.: 17/602,766

(22) PCT Filed: Sep. 1, 2021
(86) PCT No.: PCT/PH2021/050032

§ 371 Date: Oct. 10, 2021

(30) Foreign Application Priority Data
Sep. 3, 2020 (PH) 1-2020-050418

(51) Int. Cl. B01J 20/30; B01J 20/24; B01J 20/28

(52) U.S. Cl. CPC B01J 20/30; B01J 20/24; B01J 20/28047; B01J 2220/4825; B01J 2220/68

(57) ABSTRACT

Super water absorbents (SWA) based from cassava starch and acrylic acid (AAc) were prepared by gamma irradiation for agricultural applications. The influence of synthesis parameters on the gel properties of SWA and its effect on the soil water retention were investigated. Gel fraction of the different SWAs ranged from 40 to 98% and degree of swelling reached up to about 483 g water/g dry gel and SWAs exhibited gel strength up to 1000 kPa. The SWA with superior gel and soil water retention properties was found to be the formulation of 20% AAc, 30% DN, 7.5% starch and radiation dose of 20 kGy. This SWA effectively retained water in clay-rich soil while its water absorption in sandy loam increased with time. It has a biodegradation rate of 39% in 132 days. Preliminary pot experiments showed that the developed SWA can enhance the growth of lettuce.

### TECHNICAL FIELD OF THE INVENTION

This invention relates generally to composition and process of making and preparation of derivatives of starch or non-chemically modified starch (e.g. mechanically, enzymatically, or by irradiation).

### BACKGROUND OF THE INVENTION

Super water absorbents can absorb very large amount of water (many hundred times their dry weight) and retain it even under pressure. They are synthesized by crosslinking highly hydrophilic macromolecules. Super water absorbents are used in wide variety of applications such as disposable absorbent articles, in agriculture, and other fields where water absorption is needed. Acrylic acid is the main material used in the super water absorbents industry. Polyacrylic acid super water absorbents which contains ionizable groups, carboxylic when they are ionized produce fixed ions that repel one another, and this repulsion leads to greatly enhanced swelling of the network. Super water absorbents for agricultural applications are developed to improve the physical properties of soil in view of: (a) increasing their water-holding capacity, (b) increasing water use efficiency, and (c) increasing plant performance.

Most of the traditional super water absorbents on the market are 100% acrylate-based products, therefore not biodegradable and regarded as potential pollutants for the soil. It was found that the polyacrylate main chain degraded in the soils at rates of 0.12-0.24% per 6 months. Biodegradability is a desired characteristic of super water absorbent. It is the aim of this study to synthesize biodegradable super water absorbents through incorporation of starch by radiation crosslinking.

Starch is a good raw material for various applications because of their renewability, availability at low cost, biocompatibility and biodegradability. Starch is normally incorporated to super absorbent material to enhance their physico-chemical properties and biodegradability. Starch is one of the most abundant substances in nature, a renewable and almost unlimited resource.

Radiation technology has emerged as an environment-friendly, commercially viable technology with broad applications. This technology is based on the use of ionizing radiation to modify the structures and properties of materials in different industrial applications. Gamma and electron beam irradiation are found to be a very effective method for constructing three-dimensional polymeric networks of super water absorbent. It offers advantages over conventional physical or chemical methods of network formation: mild reaction conditions, negligible by-product formation, fast gelation and no need of toxic activators and crosslinking agents. It is easy to control the physical properties of the materials by the adjustment of the radiation dosage.

The objective of this study is to develop biodegradable super water absorbent from cassava starch and acrylic acid for agricultural applications. Several studies have reported the properties of radiation-processed cassava starch-based SWA but the effect of degree of neutralization and other parameters on the properties of SWA has not been studied in detail. The optimization of synthesis of cassava starch/acrylic acid based SWA using modified full factorial design, soil water retention properties and biodegradability and preliminary performance evaluation of developed SWA will be presented in this report.

Relleve et al., 2019 studied radiation-synthesized polysaccharides/polyacrylate super water absorbents and their biodegradabilities wherein polysaccharides, kappa-carrageenan (seaweed and semi-refined forms) and cassava starch were used in the preparation of SWA to improve biodegradability. Gel fraction of the different SWAs ranged from 31% to 97% and degree of swelling reached up to about 5890 g H2O/g dry gel.

CN101575401A relates to the method for producing high water absorption graft starch by sweet potato. The invention provides a method for producing high water absorption graft starch by sweet potato. The method uses the sweet potato as a raw material, deionized water as a dispersing agent, acrylic acid as a graft monomer and NSN novel initiating agent as an initiating agent.

Wilske et al., 2013 studied the biodegradability of a polyacrylate superabsorbent in agricultural soil. The study characterized the biodegradability of one acrylate-based SAP in four agricultural soils and at three temperatures. Mineralization was measured as the 13CO2 efflux from 13C-labelled SAP in soil incubations. The SAP was either single-labelled in the carboxyl C-atom or triple labelled including additionally the two C-atoms interlinked in the SAP backbone. The dual labelling allowed estimating the degradation of the polyacrylate main chain.

Yu et al., 2011 studied the Super absorbents and Semiarid Soil Properties Affecting Water Absorption. The technology studied mixing cross-linked polyacrylamides with semiarid soils may increase water availability to crops. The effects of soils, sand, and superabsorbent properties on water absorption by four superabsorbent polymers (SAPs) were studied. The amount of water absorbed by the SAPs in tap water increased with increasing polymer cation exchange capacity.

### SUMMARY OF THE INVENTION

This invention improves upon the prior art by providing a biodegradable starch/polyacrylate super water absorbent prepared by gamma-irradiation using a modified method for optimal results.

### DETAILED DESCRIPTION OF THE INVENTION

Radiation-induced crosslinking has been long recognized as a suitable method for synthesizing hydrogel wound dressing, super water absorbent, metal and dye adsorbents etc. Advantages of radiation crosslinking are no need for catalyst or additive and heat treatment. The irradiation of aqueous acrylic acid and polysaccharide solution results in the formation of radicals on the polymer chains. Also, radiolysis of water molecules produces hydroxyl radicals, which attack the polymer chains, resulting in the formation of macro-radicals. Covalent bonds are formed from the recombination of the macroradicals on different chains. Final product would be a formation of the network (gel) where polymerization and grafting occur simultaneously followed by crosslinking. The incorporation of polysaccharide like starch by means of grafting of acrylic acid or crosslinking into the network could enhance the ability of water absorption, mechanical properties and biodegradability of the super water absorbents.

Effects of different parameters (degree of neutralization, acrylic acid and starch concentration dose) on the gel properties: degree of swelling, gel fraction, and gel strength were investigated. Because of the great difference in their observed gel properties, the experiments with 0% degree of neutralization (DN) were excluded from the design. For higher DN (30-60%), a modified three-level full factorial model was used for the optimization process.

DS of SWAs ranges only from 9-27 g/g. The low degree of swelling of this formulation is not ideal for agricultural applications. The low degree of swelling and high gel fraction on this formulation is due to the proximity of acrylic molecules caused by intramolecular hydrogen bonding during radiation polymerization, grafting copolymerization, and crosslinking reaction resulting in high crosslink density of SWA network. The gel strength of this formulation was also higher reaching up to 1000 kPa. In the formulation with 15%-20% acrylic concentration, the gel strength of SWA decreases as the dose is increased suggesting possible degradation of SWA.

To study the effects of the parameters and their interactions, factorial design response fitting was carried out. As shown in Table 1, a modified three-level full factorial model was used using the three factors (acrylic acid concentration, dose, and degree of neutralization) with one 2-level factor (starch concentration). Response variables correspond to gel properties.

TABLE 1
Factors and levels of optimization experiment

| Experimental factor | Level 1 | Level 2 | Level 3 |
|---|---|---|---|
| AAc Conc (%) | 16 | 20 | 30 |
| DN (%) | 30 | 60 | 90 |
| Dose (kGy) | 10 | 15 | 20 |
| Starch Conc. (%) | 5 | 7.5/10 | |

The 3³ factorial design repeated per categorical factor required 54 treatments (i.e. 3³×2) averaged from three replications. Design Expert Version 10 (Stat-Ease, Inc. Minneapolis, MN) was used for experimental design, analysis and contour demonstration of interaction effects. The data sets were fitted in quadratic terms while checking for the goodness of fit using p-values (ANOVA). Significant terms can be used to build an equation that will correspond to each response variable.

The ratio of noise to response (F-value) of the three models (2FI for DS and quadratic for GF and MS) indicated their significance. The p-values less than 0.05 indicate model terms that were significant, such that they correlate strongly to eliciting the response (Table 3). Common significant terms between the responses were DN (A), starch conc. (D) and the interactive effect of DN with starch (AD) and acrylic conc (AC). Acrylic acid conc. only had significant correlation with mechanical strength whereas dose (10-20 kGy) did not significantly influence gel behavior.

The goodness of fit was evaluated by the coefficient of determination (R2). The response variables elicited 56-92% value indicating adequate model fit. This was also evident in the Normality Plot showing a linear correlation. Adequate precision, a measure of signal-to-noise ratio, of the model was greater than 4 signifying good discrimination.

TABLE 2
ANOVA test for determining the significance of the variables and goodness of fit of the model

| Term | F-value | Prob > F | Significant? (p < 0.05) |
|---|---|---|---|
| Degree of swelling | | | |
| Model: 2FI | 5.66 | <0.0001 | Yes |
| DN., A | 0.16 | 0.6889 | No |
| Dose, B | 0.0097 | 0.9219 | No |
| AAc Conc., C | 2.68 | 0.1087 | No |
| Starch Conc., D | 25.59 | <0.0001 | Yes |
| AB | 1.31 | 0.2588 | No |
| AC | 17.30 | 0.0001 | Yes |
| AD | 0.39 | 0.5352 | No |
| BC | 0.073 | 0.7886 | No |
| BD | 0.31 | 0.5796 | No |
| CD | 0.067 | 0.7974 | No |
| R² | 0.5662 | Equation: | |
| Adequate Precision | 10.051 | DS (g/g) = 203.90 − 55.66D + 59.41AC | |
| Gel fraction | | | |
| Model: Quadratic | 31.857369 | <0.0001 | Yes |
| DN., A | 356.288359 | <0.0001 | Yes |
| Dose, B | 0.179250 | 0.67434 | No |
| AAc Conc., C | 2.730929 | 0.10645 | No |
| Starch Conc., D | 6.762596 | 0.01308 | Yes |
| AB | 0.114884 | 0.73647 | No |
| AC | 5.469608 | 0.02457 | Yes |
| AD | 3.287749 | 0.07750 | No |
| BC | 0.242205 | 0.62538 | No |
| BD | 0.000012 | 0.99720 | No |
| CD | 0.013373 | 0.90853 | No |
| A² | 34.830714 | <0.0001 | Yes |
| B² | 0.570958 | 0.45442 | No |
| C² | 0.013166 | 0.90924 | No |
| D² | 0.516063 | 0.47681 | No |
| R² | 0.919588 | Equation: | |
| Adequate Precision | 16.660436 | GF (%) = 82.71 − 16.81A + 2.48D − 2.43AC − 8.72 A² | |
| Gel strength | | | |
| Model: Quadratic | 6.363088 | <0.0001 | Yes |
| DN, A | 2.539666 | 0.1191 | Yes |
| Dose, B | 0.139679 | 0.71062 | No |
| AAc Conc., C | 3.548608 | 0.06707 | Yes |
| Starch Conc., D | 12.32586 | 0.00115 | Yes |
| AB | 0.002509 | 0.96030 | No |
| AC | 12.99259 | 0.00088 | Yes |
| AD | 10.89191 | 0.00207 | Yes |
| BC | 2.697660 | 0.10854 | No |
| BD | 1.222211 | 0.27570 | No |
| CD | 2.610691 | 0.11421 | No |
| A² | 4.283037 | 0.04517 | Yes |
| B² | 3.390310 | 0.07320 | No |
| C² | 0.507841 | 0.48032 | No |
| D² | 3.641558 | 0.06374 | No |
| R² | 0.695510 | Equation: | |

Results showed that starch concentration and interaction of acrylic acid concentration and degree of neuralization (DN) were the major factors that influenced all response variables or gel properties of the synthesized SWAs such as the degree of swelling, gel fraction and gel strength regardless of dose absorbed (Table 2). Current irradiation dose levels probably were not diverse enough to elicit differentiable effect to gel properties of the SWA.

The degree of swelling increases when the degree of neutralization increases at high acrylic acid concentration but decreases at low acrylic acid concentration. The degree of swelling evidently decreases when starch content becomes higher (Table 2). Gel fraction decreased as the degree of neutralization increases at any levels of acrylic acid concentration. The gel strength likewise decreases with respect to the interaction effects of AAc concentration and DN, and starch concentration and DN. The decrease in gel fraction and gel strength with increasing DN is due to the stronger repulsive forces between COO⁻ groups of SWA as DN increases which inhibit recombination of polymer radicals and favorably forms chains with extended conformation which is more prone in radiation degradation.

The experimental design can be used to predict the optimum values of factors for desired response variable targets (gel properties). The synthesized SWAs were further tested by their ability to retain water in soil. The most dependable basis to determine the actual behavior of this type of SWA is by testing them in real soil system wherein considerable consequences caused by multivalent ions and microorganisms can be evaluated. The results of the optimization of soil water retention will be shown in succeeding discussion.

To predict the actual behavior of SWAs in real soil system, the soil water retention of SWA were evaluated in sandy soil (garden soil+sand at 1:1 ratio) and its efficiency was observed after exhaustive rehydration cycles. In previous experiment, formulation with 15% acrylic acid 7.5% starch 10 kGy had a drastic 40% decreased in water content and fastest to degrade among the formulations tested (data not shown). This formulation transformed into a mucus-like state after 20 days in soil mixture and unable to reabsorb water. This could be due to the microbial degradation of covalent crosslinks resulting to the irreversible collapse of SWA with insufficient degree of crosslinking to absorb and hold water. Previous results also indicated that even SWAs with higher degree of crosslinking were affected by microbial degradation at weather condition with higher humidity and lower temperature during typhoon. The higher starch content maybe responsible to the higher susceptibility of SWA to microbial degradation at this weather condition.

The synthesized SWAs were subjected to further evaluation of soil water retention during summer. Comparison of soil water retention and efficiency of SWA with formulation 30% AAc at 30%, 60% and 90% DN and 20% AAc at 60% DN was done. All SWAs has 10% starch. It was seen that the efficiency of all SWA to reabsorb water decreased over time. The soils were tilled to check for the presence of SWA. After the end of the cycle, the SWAs with high carboxylate content (30% AAc, 60% and 90% DN) had shrunk in size indicating metal saturation. The tilled SWA were immersed in water for 48 h. The 60% and 90% DN did not swell but the two SWAs 30% AAc, 30% DN-10 kGy and 20% AAc, 60% DN-20 kGy both swelled. The irreversible collapse of SWA with high degree of neutralization is maybe due to the high charge density of SWA considering the values reflected in Table 3. The high carboxylate groups present in SWA strongly attracts the multivalent cations present in soil (i.e. Ca²⁺ and Mg²⁺) displacing its potassium counter ion and formed ionic crosslinks on the surface of SWA. The garden soil used in this experiment has probably higher clay content. This occurrence has been observed also with 4 commercial SWAs from China.

TABLE 3
Charge density of different formulations of SWA

| | Charge Density* (mol COO—/kg SWA) | |
|---|---|---|
| Degree of neutralization | 20% AAc | 30% AAc |
| 30 | 0.83 | 1.25 |
| 60 | 1.66 | 2.50 |
| 90 | 2.50 | 3.75 |

*Estimated charge density of SWA assuming the degree of neutralization is equal to degree of ionization, expressed as moles of carboxylate ion per kg of preirradiated SWA.

The irreversible collapse of SWA due to microbial degradation and multivalent cations present in soil could be avoided by selecting formulation with high degree of crosslinking and with lower charge density. Optimum formulation to attain these ideal properties can be predicted using the model previously discussed. Setting optimum targets at maximum for DS, GF, and GS and excluding 15% acrylic acid concentration in synthesis parameters, the optimum formulation is 20% AAc, 30% DN, 10% Starch irradiated at 10 kGy. The gel produced would have 176 g/g DS, 93% GF, and 137 kPa GS, with desirability calculated to be 0.705. This formulation concurs to have higher gel fraction relative to 15% AAc 60% DN 10 kGy and lower charge density than 20% AAc, 60% DN. A lower starch concentration and a higher dose were also considered to prevent higher susceptibility to microbial degradation. Thus formulation, 20% AAc, 30% DN, 5-7.5% starch irradiated 20 kGy was evaluated.

Gel properties of starch/polyacrylate SWAs and commercial products are presented in Table 4. The gel properties of commercial, non-biodegradable SWA, TS has a significant difference compared to the starch-based formulations. TH is also a starch based SWA. The pure synthetic commercial SWA has a higher swelling but has poor mechanical property. The developed starch/polyacrylate SWA with 7.5% starch using the modified method has higher degree of swelling than the old method and it is comparable to TH. Modified method involves using initial KOH concentration of 5% for starch gelatinization while old method used 6.4% KOH. Although, the 5% starch have the highest degree of swelling, it was assumed that biodegradability with 5% starch may be compromised. The biodegradation data was not yet available at this time. Thus, optimized formulation was 20% AAc, 30% DN, 7.5% starch irradiated 20 kGy using the modified method.

The soil water retention of the optimized SWA in clay-rich soil (pure garden soil) was superior to the commercial products and can stand up to 169 days in pure garden soil in a laboratory set-up (data not shown). The optimized formulation was used for the mass production of SWA.

TABLE 4
Gel properties of starch/polyacrylate SWAs (20%
AAc, 30% DN, 20 kGy) and commercial products

| | Cassava | Degree of Swelling | Gel Fraction | Gel Strength |
|---|---|---|---|---|
| SWA samples | Starch | (g H₂O/g dry gel) | (%) | (kPa) |
| starch/polyacrylate^{a} | 5 | 251 ± 20 | 88 ± 3 | 98 ± 16 |
| old method | 7.5 | 155 ± 12 | 84 ± 3 | 140 ± 24 |
| starch/polyacrylate^{b} | 7.5 | 194 ± 5 | 87 ± 0.1 | 92 ± 30 |
| modified method | | | | |
| TS | — | 431 ± 33 | 76 ± 1 | 2.5 ± 1.0 |
| TH | unknown | 154 ± 31 | 88 ± 6 | 148 ± 34 |

TH = commercial, biodegradable, TS = commercial, non-biodegradable.
^{a}initial KOH = 6.4%;
^{b}initial KOH = 5%

The SWA with optimized formulation (20% AAc, 30% DN, 7.5% Starch and 20 kGy) was mass produced at laboratory scale. These synthesized SWAs from mass production have lower values of degree of swelling (DS) after storage which may be attributed to the retrogradation of starch. The soil water retention properties of optimized SWA and commercial products were evaluated in clay-rich soil (pure garden soil) and sandy loam in a greenhouse set-up. It can be seen that the different SWAs with DS 45, 47 and 57 g/g had the same water retention behavior in clay-rich soil. They were efficient up to 60 days with wet/dry cycles. It is to be noted that the commercial SWAs, TH and TS did not effectively retain water after 1 cycle even though they have higher swelling properties. The formulations of these commercial SWAs probably have higher charge density.

The behavior of SWA in sandy loam is different. The water absorption of SWA increases with time in sandy loam unlike in pure garden soil. This was observed for both commercial and the developed SWA. The water content of soil with SWAs with DS 58 and 50 g/g were relatively the same. The soil initially has water content of 60% and it increased to about 80% after third rehydration (day 22) for all SWAs. This may be due to degradation of interpenetrated starch which eliminated retrogradation effect in SWA. Thus, real crosslinking density had enabled SWA to absorb more water.

Biodegradability, which is a desired characteristic of super water absorbent, is the ability of a material to be converted into CO₂ through the action of microorganisms such as bacteria, fungi, and algae. Despite the impressive characteristics of polyacrylate SWA, its low biodegradability, typically less than 1% rate of degradation in soil per six months, has been a significant setback in its utilization. This has been the driving force in the research for amended SWA formulations that can integrate the usefulness of polyacrylate SWA with acceptable biodegradability. Incorporation of water absorbing natural polymers like polysaccharides has been the attractive option.

To evaluate the biodegradability of the optimized SWA (20% AAc, 30% DN, 20 kGy) with 5% and 7.5% starch, biodegradation tests by Microbial Oxidative Degradation Analyzer (MODA) were carried out. Our previous study showed that SWA with 10% starch (20% AAc, 38% DN) had a biodegradation rate of 42% in 85 days. The biodegradation of the optimized SWA was analyzed. Results showed that SWA containing 5% and 7.5% had biodegradation rate of 41% and 39%, respectively in 132 days. Thus, formulation with 5% starch can also be used for the preparation of SWA. It is favorable that the SWA used in agriculture biodegrades at a gradual rate to continually support the demands of plants from seedling growth to vegetative stage.

Cytotoxicity of the SWA was evaluated. Cellular toxicity is a critical issue in ensuring biocompatibility of the SWA such that it is safe to use. Results of cytotoxicity study showed that PNRI SWA had 48% cell viability while the commercial SWAs TS and TH have 28% and 0% cell viability, respectively. PNRI formulated SWA has lesser cytotoxic effect compared to the two commercial SWA.

Performance evaluation in greenhouse was conducted on lettuce. Table 5 shows the result of this evaluation. The lettuce plant did not grow to its full potential due to environmental factor (low light intensity). However, Table 5 shows that in plant height, root length, number of roots, and fresh weight, treatment A (no SWA) was statistically different to the treatments with SWA. Treatments B. C and D (treatments with SWA) were not statistically different to each other in all plant parameters except the number of roots. In number of roots, all treatments were statistically different with each other which conclude that different amount of SWA has an effect in the root system of the plant. Moreover, plants with 0.50 g SWA has the highest survival rate in all the treatments (data not shown). Therefore, 0.5 g/plant was the best treatment for lettuce. Further experiments will be conducted.

TABLE 5
Effect of different SWA treatments on the growth of lettuce

| Treatments | Average | Plant | No. | Root | No. | Fresh |
|---|---|---|---|---|---|---|
| (g SWA/ | Rehydration | Height | of | Length | of | Weight |
| plant) | Interval | (cm) | Leaves | (cm) | Roots | (g) |
| A-no SWA | 5.67 | 13.74 b | 6.44 | 2.41 b | 3.11 c | 0.37 b |
| B-0.25 | 5.83 | 18.91 a | 7.30 | 4.12 a | 3.88 bc | 0.61 a |
| C-0.50 | 8.25 | 18.69 a | 7.29 | 5.33 a | 4.51 b | 0.63 a |
| D-0.75 | 8.25 | 19.85 a | 7.09 | 4.27 a | 6.45 a | 0.67 a |

1. A process of producing biodegradable starch/polyacrylate super water absorbents comprising the steps of:
a) mixing the cassava starch with 5% KOH;
b) mechanical stirring the mixture;
c) neutralizing AAc and partially adding the neutralized AAc to the mixture;
d) mixing the slurry;
e) pouring the mixture into foil pouch;
f) sealing the foil pouch;
g) irradiating the foil pouch;
h) cutting the SWAs;
i) air drying the SWAs; and
j) drying the SWAs in an oven.

2. The process according to claim 1, wherein said duration in step b) is 45 minutes.

3. The process according to claim 1, wherein said duration in step d) is 45 minutes.

4. The process according to claim 1, wherein said foil pouch in step g) is irradiated by γ-rays at 10-20 kGy from a Co-60 source at 0.5 kGy/hr.

5. The process according to claim 1, wherein said size of SWAs in step h) is 3-5 millimeters.

6. The process according to claim 1, wherein said temperature in step j) is 50° C.

7. The process according to claim 1, wherein said duration in step j) is 24 hours.

8. A product obtained by the process according to claim 1.
